(19) United States
(12) Patent Application Publication
(10) Pub. No.: US 2013/0127955 A1
(43) Pub. Date: May 23, 2013

(54) Liquid Ejecting Head and Liquid Ejecting Apparatus

(71) Applicant: Seiko Epson Corporation, Tokyo (JP)

(72) Inventors: Miyuki Ataka, Nagano-ken (JP); Noriaki Okazawa, Nagano-ken (JP)

(73) Assignee: SEIKO EPSON CORPORATION, Tokyo (JP)

(21) Appl. No.: 13/669,603

(22) Filed: Nov. 6, 2012

(30) Foreign Application Priority Data
Nov. 18, 2011 (JP) 2011-253279

(51) Int. Cl. B41J 2/04

(52) U.S. Cl. CPC B41J 2/04
USPC 347/70

(57) ABSTRACT

A liquid ejecting head includes a nozzle plate having a first and a second nozzle row including nozzle openings; a first actuator member communicating via a first face with the nozzle openings of the first nozzle row, and including a first flow path plate including individual flow paths having an opening on a second face, a vibrating plate, and first pressure generators; and a second actuator member and communicating via a first face thereof with the nozzle openings of the second nozzle row, and including a second flow path plate including individual flow paths formed as a recess open to a second face thereof and nozzle communication paths communicating with the nozzle openings, a vibrating plate, and second pressure generators. The individual flow paths of the first and the second actuator member are arranged so as to at least partially overlap when viewed in the thickness direction.

### BACKGROUND

1. Technical Field

The present invention relates to a liquid ejecting head and a liquid ejecting apparatus configured to eject a liquid, more particularly ink, through nozzle openings.

2. Related Art

The liquid ejecting head can be typically exemplified by an ink jet recording head configured to change pressure on the ink in a pressure chamber communicating with nozzle openings, to thereby dispense ink droplets through the nozzle openings.

In order to increase the density of the nozzle openings of such an ink jet recording head, the nozzle openings are arranged in a staggered pattern composed of a first nozzle row and a second nozzle row, in each of which the nozzle openings are aligned in a first direction, the first nozzle row and the second nozzle row being aligned in a second direction intersecting the first direction, such that the nozzle openings of the first nozzle row and those of the second nozzle row do not overlap when viewed in the second direction. Such an arrangement is proposed, for example, in JP-A-11-309877.

On the other hand, however, a certain room has to be reserved for flow paths and partitions necessary for forming individual flow paths. Accordingly, arranging the nozzle openings in the staggered pattern in which the first nozzle row and the second nozzle row are shifted in the first direction, as disclosed in JP-A-11-309877, is not yet sufficient for reducing the pitch between the nozzle openings thereby increasing the density thereof to a satisfactory extent.

The foregoing drawback is incidental not only to ink jet recording heads, but also to liquid ejecting heads that eject a liquid other than ink.

### SUMMARY

An advantage of some aspects of the invention is provision of a liquid ejecting head and a liquid ejecting apparatus that can be built in smaller dimensions, with increased density of nozzle openings.

In an aspect, the invention provides a liquid ejecting head including a nozzle plate having a first nozzle row including a plurality of nozzle openings aligned in a first direction and a second nozzle row including a plurality of nozzle openings aligned in the first direction, the first nozzle row and the second nozzle row being aligned in a second direction orthogonal to the first direction, such that the nozzle openings of the first nozzle row and the nozzle openings of the second nozzle row are deviated from each other in the first direction; a first actuator member communicating via a first face thereof with the nozzle openings of the first nozzle row, and including a first flow path plate including a plurality of individual flow paths each having an opening on the side of a second face opposite the first face, a vibrating plate provided on the side of the second face of the first flow path plate opposite the first face, and a plurality of first pressure generators that change pressure in the individual flow paths; and a second actuator member provided on the second face of the first actuator member and communicating via a first face thereof with the nozzle openings of the second nozzle row, and including a second flow path plate including a plurality of individual flow paths each formed as a recess having an opening on the side of a second face of the second actuator member opposite the first face and a plurality of nozzle communication paths each communicating between the individual flow path and the nozzle opening located on the side of the first face, a vibrating plate provided on the side of the second face of the second flow path plate, and a plurality of second pressure generators that change pressure in the individual flow paths, wherein the individual flow paths of the first actuator member and the individual flow paths of the second actuator member are arranged so as to at least partially overlap when viewed in the direction in which the first actuator member and the second actuator member are stacked.

Forming the individual flow paths as a recess as above allows the pressure chambers of the first actuator member and the individual flow paths of the second actuator member to be located so as to at least partially overlap when viewed in the direction in which the actuator members are stacked. Such a configuration allows the nozzle openings to be arranged in higher density in the first direction, and thus enables reduction in size of the liquid ejecting head in the first direction.

It is preferable that the second actuator member includes first retention chambers each formed as a recess having an opening on the side of the first actuator member so as to accommodate the first pressure generator provided on the vibrating plate in the first actuator member, and the first retention chambers are located so as to at least partially overlap the individual flow path in the second actuator member, in a view in the direction in which the first actuator member and the second actuator member are stacked. In this case, forming the individual flow paths in the second actuator member in the recessed shape allows the pressure chambers and the retention chambers to be arranged so as to overlap, thereby allowing the nozzle openings to be arranged in higher density in the first direction, and thus enabling reduction in size of the liquid ejecting head.

It is preferable that a cover plate is provided on the second face of the second actuator member, the cover plate including second retention chambers that each accommodate the second pressure generator provided on the vibrating plate in the second actuator member. With such a configuration, the second pressure generators of the second actuator member can be protected.

It is preferable that a lead-out wiring drawn out from the first pressure generator of the first actuator member and the second pressure generator of the second actuator member is disposed so as to extend to a surface of the cover plate opposite the second actuator member, and connected to an external wiring. Such a configuration ensures the connection between the pressure generators of the stacked actuator members and the external wiring.

It is preferable that a lead-out wiring drawn out from the first pressure generator of the first actuator member and the second pressure generator of the second actuator member is disposed so as to extend to a region on the second face of the first actuator member uncovered with the second actuator member, and electrically connected to an external wiring. Such a configuration ensures the connection between the pressure generators of the stacked actuator members and the external wiring.

Further, it is preferable that a lead-out wiring drawn out from the first pressure generator of the first actuator member is disposed so as to extend to a region uncovered with the second actuator member, on the side of the first flow path plate on which the first pressure generator is provided, and a lead-out wiring drawn out from the second pressure generator of the second actuator member is disposed on the side of the second flow path plate on which the second pressure generator is provided. Such a configuration eliminates the need to route the lead-out wiring in the direction in which the actuator members are stacked, thereby suppressing defective formation or disconnection of the lead-out wiring and facilitating the actuator members to be stacked in a multiple layers.

Further, it is preferable that the first and the second actuator member include a manifold communicating in common with the plurality of pressure chambers, and the individual flow paths of the first actuator member and the individual flow paths of the second actuator member have the same distance and volume between the manifold and the center of vibration of the vibrating plate on the individual flow path, and the same distance and volume between the center of vibration of the vibrating plate on the individual flow path and the nozzle opening. Forming thus the individual flow paths of the first and the second actuator member with the same distance (flow path length) and volume between the manifold and the center of vibration, as well as between the center of vibration and the nozzle opening, provides uniform dispensing characteristics to the ink droplets ejected through the nozzle openings.

In another aspect, the invention provides a liquid ejecting apparatus that includes the foregoing liquid ejecting head.

The liquid ejecting apparatus thus configured can be built in reduced dimensions, and enables the liquid droplets to land on a recording medium in high density.

### BRIEF DESCRIPTION OF THE DRAWINGS

The invention will be described with reference to the accompanying drawings, wherein like numbers reference like elements.

FIG. 1 is a plan view of a recording head according to an embodiment 1 of the invention.

FIG. 2 is a cross-sectional view of the recording head according to the embodiment 1.

FIG. 3 is another cross-sectional view of the recording head according to the embodiment 1.

FIG. 4 is still another cross-sectional view of the recording head according to the embodiment 1.

FIG. 5 is a cross-sectional view of a recording head according to an embodiment 2 of the invention.

FIG. 6 is another cross-sectional view of the recording head according to the embodiment 2.

FIG. 7 is a cross-sectional view of a recording head according to a variation of the embodiment 2.

FIG. 8 is a plan view of a recording head according to an embodiment 3 of the invention.

FIG. 9 is a cross-sectional view of the recording head according to the embodiment 3.

FIG. 10 is a cross-sectional view of a recording head according to a variation of the embodiment 3.

FIG. 11 is cross-sectional view of a recording head according to another variation of the embodiment 3.

FIG. 12 is a cross-sectional view of a recording head according to an embodiment 4 of the invention.

FIG. 13 is another cross-sectional view of the recording head according to the embodiment 4.

FIG. 14 is a cross-sectional view of a recording head according to an embodiment 5 of the invention.

FIG. 15 is another cross-sectional view of the recording head according to the embodiment 5.

FIG. 16 is a cross-sectional view of a recording head according to an additional embodiment of the invention.

FIG. 17 is a schematic perspective view showing an ink jet recording apparatus according to an embodiment of the invention.

### DESCRIPTION OF EXEMPLARY EMBODIMENTS

Hereafter, exemplary embodiments of the invention will be described in details.

### Embodiment 1

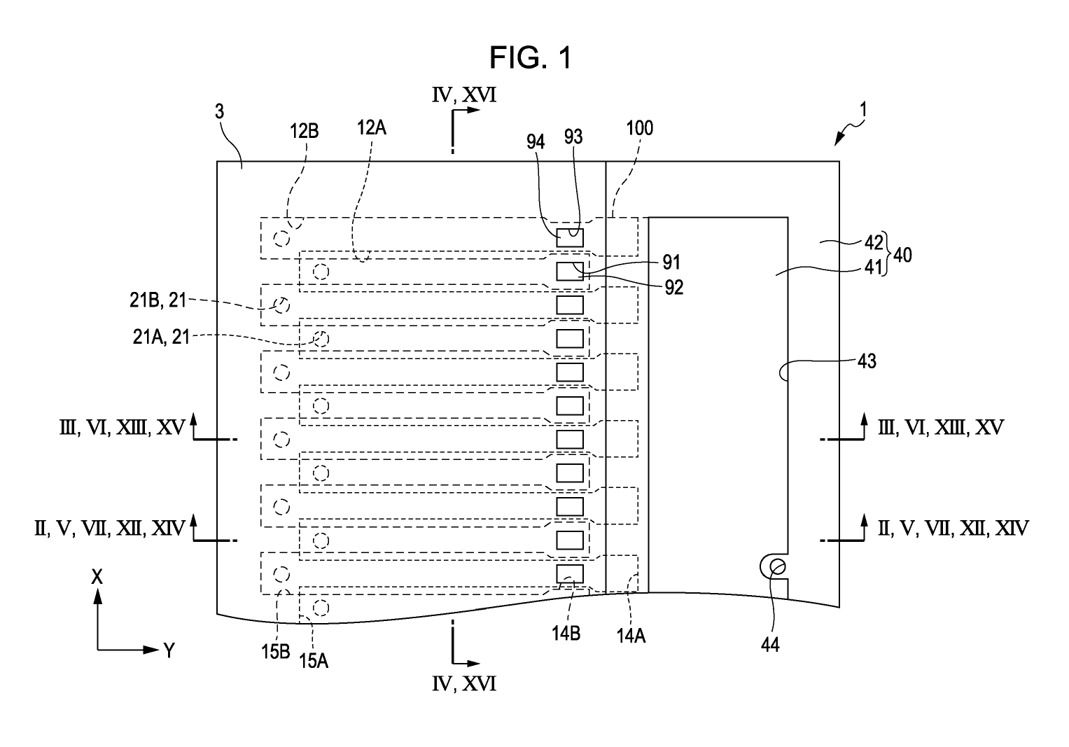

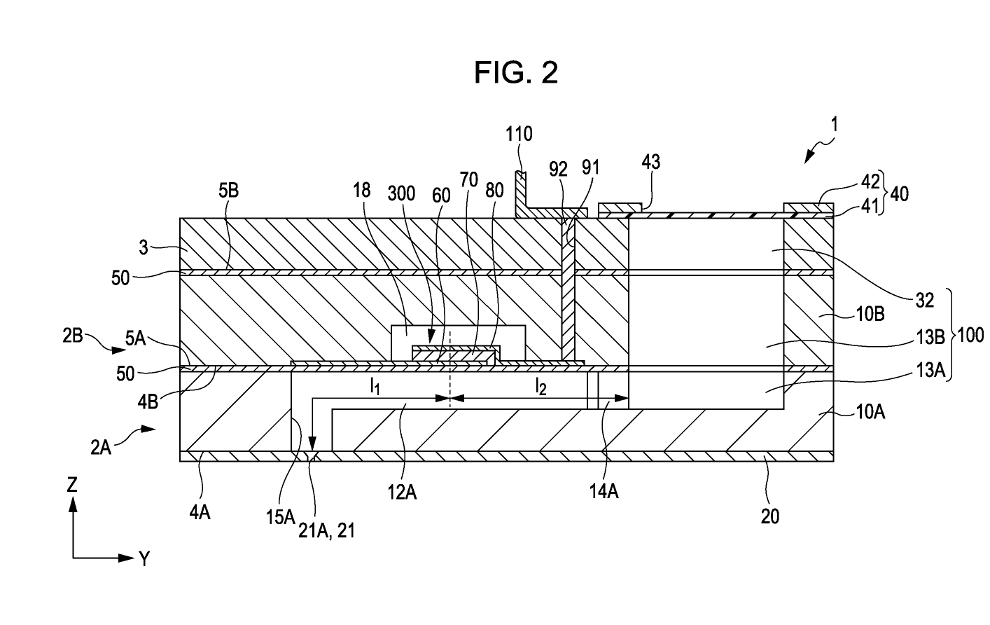

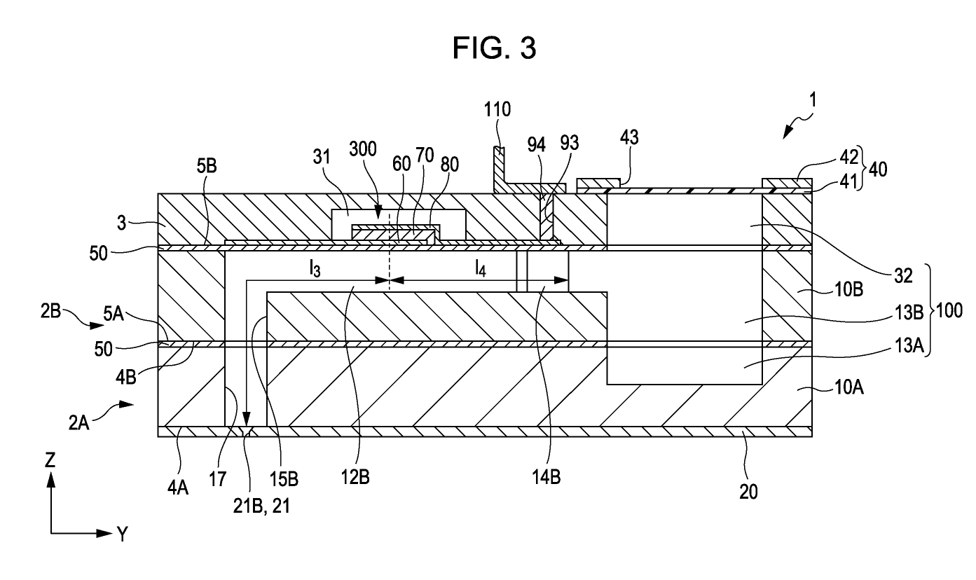

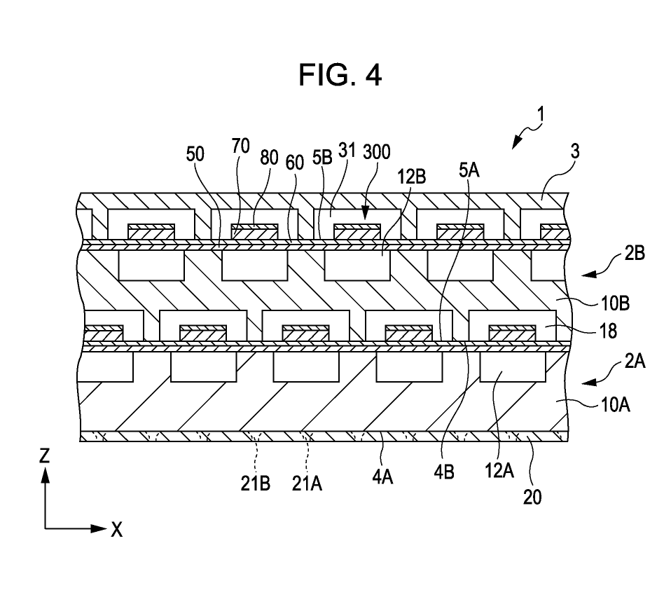

FIG. 1 is a plan view of an ink jet recording head according to an embodiment 1 of the invention, exemplifying the liquid ejecting head, viewed from the side of a cover plate. FIG. 2 is a cross-sectional view taken along a line II-II in FIG. 1; FIG. 3 is a cross-sectional view taken along a line III-III in FIG. 1; and FIG. 4 is a cross-sectional view taken along a line IV-IV in FIG. 1.

As shown in these drawings, the ink jet recording head 1 according to this embodiment includes a first actuator member 2A and a second actuator member 2B (collectively referred to as actuator member 2 as the case may be), a nozzle plate 20 attached to the first actuator member 2A, and a cover plate 3 attached to the second actuator member 2B.

The nozzle plate 20 is a plate-shaped member formed of a metal such as stainless steel, a semiconductor such as silicon, a ceramic, or the like. The nozzle plate 20 includes a first nozzle row including first nozzle openings 21A aligned in a first direction X and a second nozzle row including second nozzle openings 21B aligned in the first direction X. The first nozzle row including the first nozzle openings 21A and the second nozzle row including the second nozzle openings 21B are aligned in a second direction Y. The second nozzle openings 21B of the second nozzle row are each located between the first nozzle openings 21A of the first nozzle row, in the first direction X. Conversely, the first nozzle openings 21A of the first nozzle row are each located between the second nozzle openings 21B of the second nozzle row, in the first direction X. In other words, the nozzle openings 21 form a so-called staggered pattern, in which the first nozzle openings 21A and the second nozzle openings 21B are alternately arranged in the first direction X.

In addition, the pitch (spacing) between the first nozzle openings 21A of the first nozzle row in the first direction and the pitch between the adjacent second nozzle openings 21B of the second nozzle row in the first direction are the same. The second nozzle openings 21B are each located at the midpoint of the pitch between the first nozzle openings 21A, in the first direction X. Accordingly, the first nozzle opening 21A and the second nozzle opening 21B are aligned at intervals corresponding to a half of the pitch between the first nozzle openings 21A in the first direction X. Arranging thus the first nozzle openings 21A and the second nozzle openings 21B enables the density of the nozzle openings to be doubled, compared with the case of only forming the first nozzle openings 21A.

In this embodiment, the direction in which the first nozzle openings 21A will be referred to as first direction X, and the direction orthogonal to the first direction X will be referred to as second direction Y.

The actuator member 2 includes a first actuator member 2A and a second actuator member 2B. The nozzle plate 20 is attached to one of the faces of the first actuator member 2A, namely a first face 4A, and the second actuator member 2B is attached to a second face 5A of the first actuator member 2A, opposite the first face 4A. Here, a first face 4B of the second actuator member 2B on the side of the nozzle plate 20 is attached to the second face 5A of the first actuator member 2A, and the cover plate 3 is provided on a second face 5B of the second actuator member 2B, opposite the first face 4B.

Referring to FIG. 2, a first flow path plate 10A constituting the first actuator member 2A is composed of a ceramic material such as alumina (Al₂O₃) or zirconia (ZrO₂).

The first flow path plate 10A includes a plurality of first pressure chambers 12A aligned in the direction in which the nozzle openings 21 (first nozzle openings 21A) that dispense ink of the same color are aligned, i.e., in the first direction X.

The first pressure chambers 12A of the first flow path plate 10A are open toward the second face 5A opposite the first face 4A, and formed as a recess in the first flow path plate 10A so as not to reach the first face 4A, i.e., not to penetrate through the first flow path plate 10A in a thickness direction Z. Here, the thickness direction Z stands for the direction from the first face 4A toward the second face 5A.

The first flow path plate 10A also includes a first manifold region 13A provided so as to form a manifold at an end portion of the first pressure chamber 12A in the second direction Y, orthogonal to the first direction X. The first manifold region 13A is continuously formed along the plurality of first pressure chambers 12A in the first direction X. The first manifold region 13A communicates with the plurality of first pressure chambers 12A through a first supply path 14A provided in each of the first pressure chambers 12A. The first manifold region 13A is, like the first pressure chamber 12A, formed as a recess having an opening oriented to the second face 5A. Alternatively, the first manifold region 13A may be formed so as to penetrate through the first flow path plate 10A and the opening of the first manifold region 13A in the first face 4A may be covered with the nozzle plate 20.

The first supply path 14A has the same depth as the first pressure chamber 12A in the thickness direction Z and a narrower width than the first pressure chamber 12A in the first direction X, and serves to adjust the amount of ink to be squeezed toward the nozzle opening 21. Although the first supply path 14A is formed by narrowing the flow path from the both sides in this embodiment, the first supply path 14A may be formed by narrowing the flow path only from either side. Alternatively, the first supply path 14A may be formed by narrowing the flow path in the thickness direction Z (direction in which the first flow path plate 10A and the nozzle plate 20 are stacked), instead of narrowing the flow path in the width direction. Hereinafter, the first pressure chamber 12A and the first supply path 14A will be referred to as individual flow path of the first actuator member 2A.

In addition, the first flow path plate 10A includes a first nozzle communication path 15A communicating with the end portion of the first pressure chamber 12A opposite the first supply path 14A in the second direction Y.

The first nozzle communication path 15A is formed so as to penetrate through the first flow path plate 10A in the thickness direction Z for communication with the first nozzle opening 21A of the nozzle plate 20, at the position corresponding to the first nozzle opening 21A, to thereby allow communication between the first pressure chamber 12A and the first nozzle opening 21A through the first nozzle communication path 15A.

Thus, the first flow path plate 10A includes the individual flow path composed of the first supply path 14A and the first pressure chamber 12A formed in the recessed shape, the first nozzle communication path 15A penetrating through the first flow path plate 10A in the thickness direction Z, and the first manifold region 13A.

To the first face 4A where the opening of the first nozzle communication path 15A is located the nozzle plate 20 is attached, the nozzle plate 20 including the nozzle openings 21 communicating with the first nozzle communication path 15A, namely the first nozzle opening 21A.

In this embodiment, a thin vibrating plate 50 formed of, for example, a ceramic material of 1 to 5 μm in thickness (in Z-direction) is attached to the second face 5A which includes the opening of the first pressure chamber 12A of the first flow path plate 10A, such that the opening of the first pressure chamber 12A is covered with the vibrating plate 50.

In addition, piezoelectric elements 300, exemplifying the first pressure generator, that change pressure onto the ink (liquid) in the first pressure chamber 12A are provided on the vibrating plate 50 (opposite the first flow path plate 10A), at the positions corresponding to the respective first pressure chambers 12A.

The piezoelectric elements 300 each include a first electrode 60 located on the vibrating plate 50, a piezoelectric layer 70 independently corresponding to each of the first pressure chambers 12A, and a second electrode 80 provided on each of piezoelectric layer 70. The first electrode 60 is provided in common for the piezoelectric elements 300 aligned in the first direction X so as to serve as the common electrode of the piezoelectric elements 300, and to serve also as a part of the vibrating plate 50. In addition, the first electrode 60 extends in the second direction Y of the piezoelectric elements 300 from the position corresponding to the first nozzle communication path 15A to the vicinity of an end portion of the piezoelectric layer 70 on the side of the first supply path 14A.

The piezoelectric layer 70 may be formed by attaching a green sheet composed of a piezoelectric material, or through a printing process. Alternatively, a piezoelectric precursor may be formed on the first electrode 60 by sputtering or a solution method, and the piezoelectric precursor may be sintered for crystallization so as to form the piezoelectric layer 70.

The second electrode 80 is provided on each of the piezoelectric elements 300 so as to serve as the individual electrode of the piezoelectric element 300. The second electrode 80 is formed so as to extend in the second direction Y on the side of the end portion of the piezoelectric element 300 opposite the first nozzle communication path 15A corresponding to the first electrode 60. Although the first electrode 60 serves as the common electrode and the second electrode 80 serves as the individual electrode in this embodiment, the first electrode may be provided on each piezoelectric layer so as to serve as the individual electrode and the second electrode may be provided for the plurality of piezoelectric layers so as to serve as the common electrode.

As described above, the first actuator member 2A according to this embodiment is composed of the first flow path plate 10A, the vibrating plate 50, and the piezoelectric element 300.

Now, the second actuator member 2B is attached to the second face 5A of the first actuator member 2A, opposite the first face 4A to which the nozzle plate 20 is attached.

Referring to FIG. 3, a second flow path plate 10B constituting the second actuator member 2B is composed of a ceramic material such as alumina (Al₂O₃) or zirconia (ZrO₂), and has the same thickness in the Z-direction as the first flow path plate 10A in this embodiment. One of the faces of the second flow path plate 10B on the side of the nozzle plate 20, i.e., the first face 4B, is attached to the second face 5A of the first actuator member 2A.

The second flow path plate 10B includes a plurality of second pressure chambers 12B aligned in the first direction X and each formed as a recess open toward the second face 5B opposite the first face 4B attached to the first flow path plate 10A.

The second pressure chambers 12B are formed in the same dimensions as the first pressure chamber 12A, in width in the first direction X, length in the second direction Y, and depth from the second face 5B toward the first face 4B in the thickness direction Z.

The second flow path plate 10B also includes a second manifold region 13B provided so as to form a manifold 100 at an end portion of the second pressure chamber 12B in the second direction Y, orthogonal to the first direction X. The second manifold region 13B is continuously formed along the plurality of second pressure chambers 12B in the first direction X. The second manifold region 13B communicates with the plurality of second pressure chambers 12B through a second supply path 14B provided in each of the second pressure chambers 12B. Here, the second manifold region 13B is formed so as to penetrate through the second flow path plate 10B in the thickness direction Z, and to thus communicate with the first manifold region 13A.

The second supply path 14B has, like the first supply path 14A, the same depth as the second pressure chamber 12B in the thickness direction Z and a narrower width than the second pressure chamber 12B in the first direction X, and serves to adjust the amount of ink to be squeezed toward the nozzle opening 21. Although the second supply path 14B is formed by narrowing the flow path from the both sides in this embodiment, the second supply path 14B may be formed by narrowing the flow path only from either side. Alternatively, the second supply path 14B may be formed by narrowing the flow path in the thickness direction Z (direction in which the first flow path plate 10A and the nozzle plate 20 are stacked), instead of narrowing the flow path in the width direction. Hereinafter, the second pressure chamber 12B and the second supply path 14B will be referred to as individual flow path of the second actuator member 2B.

In addition, the second flow path plate 10B includes a second nozzle communication path 15B communicating with the end portion of the second pressure chamber 12B opposite the second supply path 14B in the second direction Y.

The second nozzle communication path 15B is formed so as to penetrate through the second flow path plate 10B in the thickness direction Z for communication with the second nozzle opening 21B of the nozzle plate 20, at the position corresponding to the second nozzle opening 21B, to thereby allow communication between the second pressure chamber 12B and the second nozzle opening 21B through the second nozzle communication path 15B. In this embodiment, the second nozzle communication path 15B communicates with a connection path 17 formed so as to penetrate through the first flow path plate 10A in the thickness direction Z, to thereby communicate with the nozzle opening 21 of the nozzle plate 20, namely the nozzle opening 21B, through the connection path 17. Thus, the second pressure chamber 12B communicates with the second nozzle opening 21B through the second nozzle communication path 15B and the connection path 17.

As described above, the second flow path plate 10B includes the individual flow path composed of the second supply path 14B and the second pressure chamber 12B formed in the recessed shape, the second nozzle communication path 15B penetrating through the second flow path plate 10B in the thickness direction Z, and the second manifold region 13B.

Here, the individual flow paths (second pressure chambers 12B) of the second actuator member 2B are shifted from the individual flow paths (first pressure chambers 12A) of the first actuator member 2A in the second direction Y to a position farther from the manifold 100, when viewed in the direction in which the first flow path plate 10A and the second flow path plate 10B are stacked, i.e., in the thickness direction Z. In addition, the individual flow paths (second pressure chambers 12B) of the second actuator member 2B are each located between the adjacent individual flow paths (first pressure chambers 12A) of the first actuator member 2A in the first direction X, when viewed in the direction in which the first flow path plate 10A and the second flow path plate 10B are stacked, i.e., in the thickness direction Z. Further, the first pressure chambers 12A and the second pressure chambers 12B are aligned so as to at least partially overlap, when viewed in the direction in which the first flow path plate 10A and the second flow path plate 10B are stacked, i.e., in the thickness direction Z.

In this embodiment, the expression to the effect that the individual flow paths (first pressure chambers 12A) of the first actuator member 2A and the individual flow paths (second pressure chambers 12B) of the second actuator member 2B at least partially overlap when viewed in the direction in which the flow path plates are stacked represents the state that the individual flow paths overlap in both of the first direction X and the second direction Y. For example, although the individual flow paths (first pressure chambers 12A) of the first actuator member 2A and the individual flow paths (second pressure chambers 12B) of the second actuator member 2B overlap in the first direction X, the configuration will not be described as “at least partially overlapping when viewed in the direction in which the flow path plates are stacked” unless the individual flow paths overlap in the second direction Y. This is because the configuration in which the individual flow paths (first pressure chambers 12A) of the first actuator member 2A and the individual flow paths (second pressure chambers 12B) of the second actuator member 2B overlap in the first direction X but not in the second direction Y includes a situation where the individual flow paths of the first actuator member 2A and those of the second actuator member 2B are spaced from each other in the second direction Y in a plan view in the thickness direction Z, though the respective individual flow paths are locate at the same position (coordinate) in the first direction X. Such a situation impedes the nozzle openings 21 from being arranged in high density, which leads to an increase in dimension of the ink jet recording head 1 in the second direction Y. In this embodiment, locating the individual flow paths of the first actuator member 2A and those of the second actuator member 2B so as to overlap both in the first direction X and in the second direction Y in a plan view in the thickness direction Z allows the nozzle openings 21 to be arranged in higher density, and enables the reduction in size of the liquid ejecting head 1 in the second direction Y.

For the same reason, although the individual flow paths (first pressure chambers 12A) of the first actuator member 2A and the individual flow paths (second pressure chambers 12B) of the second actuator member 2B overlap in the second direction Y, the configuration will not be described as “at least partially overlapping when viewed in the direction in which the flow path plates are stacked” unless the individual flow paths overlap in the first direction X.

Further, the expression that the individual flow paths (first pressure chambers 12A) of the first actuator member 2A and the individual flow paths (second pressure chambers 12B) of the second actuator member 2B at least partially overlap when viewed in the direction in which the first flow path plate 10A and the second flow path plate 10B are stacked (thickness direction Z) will exclude the case where the individual flow paths of the first actuator member 2A and the individual flow paths of the second actuator member 2B are located at exactly the same positions in a plan view in the thickness direction Z.

It is because the individual flow paths of the second actuator member 2B are formed in the recessed shape so as not to penetrate through the second flow path plate 10B, that the individual flow paths of the first actuator member 2A and the individual flow paths of the second actuator member 2B can thus be located so as to at least partially overlap when viewed in the direction in which the first actuator member 2A and the second actuator member 2B are stacked, i.e., in the thickness direction Z. If the individual flow paths of the second actuator member 2B were formed so as to penetrate through the second flow path plate 10B, the second flow path plate 10B would interfere with the piezoelectric element 300 of the first actuator member 2A, which would disable the individual flow paths of the actuator member 2B from being located so as to at least partially overlap the individual flow paths of the first actuator member 2A when viewed in the direction in which the first actuator member 2A and the second actuator member 2B are stacked, i.e., in the thickness direction Z. In other words, if the individual flow paths of the second actuator member 2B were formed so as to penetrate through the second flow path plate 10B, the individual flow paths of the second actuator member 2B would have to be located between the adjacent piezoelectric elements 300 of the first actuator member 2A in the first direction X, and the piezoelectric elements 300 of the first actuator member 2A would have to be located between the individual flow paths of the second actuator member 2B in the first direction X. In order to thus locate the individual flow paths of the second actuator member 2B between the adjacent piezoelectric elements 300 of the first actuator member 2A in the first direction X, and the piezoelectric elements 300 of the first actuator member 2A between the individual flow paths of the second actuator member 2B in the first direction X, the pitch between the adjacent first pressure chambers 12A in the first direction X has to be increased, and likewise the pitch between the adjacent second pressure chambers 12B in the first direction X. In this case, the pitch between the nozzle openings 21 (both first nozzle openings 21A and second nozzle openings 21B) aligned in the first direction X has to be increased, which disables the nozzle openings 21 from being arranged in higher density in the first direction X thereby increasing the size of the first flow path plate 10A and the second flow path plate 10B in the first direction X. In this embodiment, in contrast, the individual flow paths of the second actuator member 2B are formed in the recessed shape so as not to penetrate through the second flow path plate 10B, so that the individual flow paths of the first actuator member 2A and the individual flow paths of the second actuator member 2B can be located so as to at least partially overlap when viewed in the direction in which the first actuator member 2A and the second actuator member 2B are stacked. Such a configuration allows the pitch between the adjacent first pressure chambers 12A and between the adjacent second pressure chambers 12B in the first direction X to be reduced thus allowing the nozzle openings 21 to be arranged in a reduced pitch, i.e., in higher density, and enables the first flow path plate 10A and the second flow path plate 10B to be built in smaller dimensions both in the first direction X and in the second direction Y.

In addition, the second pressure chambers 12B are shifted from the first pressure chambers 12A in the second direction Y to a position farther from the manifold 100, and located between the adjacent first pressure chambers 12A in the first direction X. Accordingly, the second nozzle communication paths 15B communicating with the second pressure chamber 12B are shifted to a position farther from the manifold 100 than are the first nozzle communication paths 15A in the second direction Y, as is the second pressure chamber 12B with respect to the first pressure chamber 12A, and located between the adjacent first nozzle communication paths 15A in the first direction X. The second nozzle communication paths 15B thus located communicate, as described above, with the second nozzle opening 21B among the nozzle openings 21 of the nozzle plate 20, through the connection path 17.

Although the first pressure chambers 12A and the second pressure chambers 12B are arranged so as to at least partially overlap in a plan view in the direction in which the first flow path plate 10A and the second flow path plate 10B are stacked, i.e., in the thickness direction Z in this embodiment, the individual flow paths of the first actuator member 2A and the individual flow paths of the second actuator member 2B may be arranged so as to at least partially overlap in a plan view in the direction in which the first flow path plate 10A and the second flow path plate 10B are stacked, i.e., in the thickness direction Z. In other words, for example, the first pressure chamber 12A and the second supply path 14B may be located so as to at least partially overlap in a plan view in the thickness direction Z. It is to be noted that which of the individual flow paths are located so as to overlap in a view in the thickness direction Z may vary depending on the positional relationship between the first nozzle openings 21A and the second nozzle openings 21B, as well as on the length of the respective individual flow paths.

Further, the vibrating plate 50 is provided on the second face 5B of the second flow path plate 10B, as on the first flow path plate 10A, and the piezoelectric elements 300, exemplifying the second pressure generator, that change pressure onto the ink (liquid) in the second pressure chamber 12B are provided on the vibrating plate 50 at the positions corresponding to the respective second pressure chambers 12B. The vibrating plate 50 and the piezoelectric elements 300 provided on the second flow path plate 10B are configured in the same way as those provided on the first flow path plate 10A, and therefore the same numerals are given and the description thereof will not be repeated.

In this embodiment, a distance l₁ and a volume between the center of vibration in the second direction Y of the vibrating plate 50 on the individual flow paths of the first actuator member 2A and the first nozzle opening 21A are equal to a distance l₃ and a volume between the center of vibration in the second direction Y of the vibrating plate 50 on the individual flow paths of the second actuator member 2B and the second nozzle opening 21B. Likewise, a distance l₂ and a volume between the center of vibration in the second direction Y of the vibrating plate 50 on the individual flow paths of the first actuator member 2A and the manifold 100 (first manifold region 13A) are equal to a distance l₄ and a volume between the center of vibration in the second direction Y of the vibrating plate 50 on the individual flow paths of the second actuator member 2B and the manifold 100 (second manifold region 13B).

Here, the center of vibration of the vibrating plate 50 in the second direction Y corresponds to the center of the piezoelectric operative portion of the piezoelectric element 300, which is the substantial working portion thereof, in the second direction Y. The piezoelectric operative portion is defined in this embodiment as the portion of the piezoelectric layer 70, interposed between the first electrode 60 and the second electrode 80, that suffers voltage distortion when a voltage is applied to those electrodes. The distances l₁, l₃ are taken in the direction in which the ink flows. The distance l₁ corresponds to the total of the distance between the center of vibration of the first pressure chamber 12A and the first nozzle communication path 15A in the second direction Y and the length of the first nozzle communication path 15A in the thickness direction Z. The distance l₃ corresponds to the total of the distance between the center of vibration of the second pressure chamber 12B and the second nozzle communication path 15B in the second direction Y, and the length of the second nozzle communication path 15B and the connection path 17 in the thickness direction Z. The distances l₂ and l₄ correspond to the total of the distance from the center of vibration of the first pressure chamber 12A to the first supply path 14A and the length of the first supply path 14A in the second direction Y, and the total of the distance from the center of vibration of the second pressure chamber 12B to the second supply path 14B and the length of the second supply path 14B in the second direction Y, respectively.

Making thus the distance l₁ and the volume between the center of vibration of the vibrating plate 50 on the individual flow paths of the first actuator member 2A and the first nozzle opening 21A equal to the distance l₃ and the volume between the center of vibration of the vibrating plate 50 on the individual flow paths of the second actuator member 2B and the second nozzle opening 21B, and making the distance l₂ and the volume between the center of vibration of the vibrating plate 50 (in the second direction Y) of the first actuator member 2A and the manifold 100 (first manifold region 13A) equal to the distance l₄ and the volume between the center of vibration of the vibrating plate 50 (in the second direction Y) of the second actuator member 2B and the manifold 100 (second manifold region 13B) enable the pressure status and the vibration status of meniscus in the first nozzle openings 21A and the second nozzle openings 21B to be uniform, upon activating the piezoelectric elements 300 in the first actuator member 2A and the second actuator member 2B so as to cause pressure fluctuation to the ink in the first pressure chamber 12A and the second pressure chamber 12B, to thereby give uniform dispensing characteristics (flying speed and weight of ink droplets) to the ink droplets ejected through the first nozzle openings 21A and to those ejected through the second nozzle opening 21B thus allowing the ink droplets to land on the recording medium with uniform dispensing characteristics.

If the distance l₁ and the volume between the center of vibration in the second direction Y of the vibrating plate 50 on the individual flow paths of the first actuator member 2A and the first nozzle opening 21A were not equal to the distance l₃ and the volume between the center of vibration in the second direction Y of the vibrating plate 50 on the individual flow paths of the second actuator member 2B and the second nozzle opening 21B, and the distance l₂ and the volume between the center of vibration in the second direction Y of the vibrating plate 50 on the individual flow paths of the first actuator member 2A and the manifold 100 (first manifold region 13A) were not equal to the distance l₄ and the volume between the center of vibration in the second direction Y of the vibrating plate 50 on the individual flow paths of the second actuator member 2B and the manifold 100 (second manifold region 13B), the dispensing characteristics (flying speed and weight of ink droplets) of the ink droplets ejected through the first nozzle openings 21A and those ejected through the second nozzle opening 21B would become uneven.

In addition, the second flow path plate 10B includes first retention chambers 18 of a size that allows the piezoelectric elements 300 of the first flow path plate 10A to operate undisturbed, located at positions corresponding to the respective piezoelectric elements 300. The first retention chambers 18 are each formed as a recess having an opening on the side of the second flow path plate 10B opposing the first flow path plate 10A, i.e., on the side of the first face 4B, and independently provided on the corresponding piezoelectric element 300. The dimensions of the first retention chamber 18 are not specifically limited provided that the piezoelectric element 300 can operate undisturbed, and the first retention chamber 18 may be either sealed or unsealed.

The first retention chambers 18 are each located so as to partially overlap the second pressure chamber 12B when viewed in the direction in which the first flow path plate 10A and the second flow path plate 10B are stacked, i.e., in the thickness direction Z. Accordingly, the first retention chambers 18 are formed in a depth that can avoid interference with the second pressure chamber 12B. The depth of the first retention chamber 18 may be appropriately determined depending on the thickness of the second flow path plate 10B and the piezoelectric element 300, and the depth of the second pressure chamber 12B.

Further, the cover plate 3 is provided on the second face 5B of the second flow path plate 10B, on which the piezoelectric elements 300 are provided, the cover plate 3 including second retention chambers 31 of a size that allows the piezoelectric elements 300 of the second flow path plate 10B to operate undisturbed, located at positions corresponding to the respective piezoelectric elements 300. The second retention chamber 31 are independently provided on the corresponding piezoelectric element 300, like the first retention chambers 18 formed in the second flow path plate 10B. Alternatively, the first retention chambers 18 of the second flow path plate 10B and the second retention chamber 31 of the cover plate 3 may be continuously formed over the plurality of piezoelectric elements 300.

The cover plate 3 includes a third manifold region 32 communicating with the second manifold region 13B of the second flow path plate 10B, and the third manifold region 32 constitutes a part of the manifold 100, together with the first manifold region 13A and the second manifold region 13B. Thus, the manifold 100 of this embodiment is constituted of the first manifold region 13A in the first flow path plate 10A, the second manifold region 13B in the second flow path plate 10B, and the third manifold region 32 in the cover plate 3.

The cover plate 3 may be formed of a ceramic plate or the like, as the first flow path plate 10A and the second flow path plate 10B. Further, a compliance substrate 40 including a covering film 41 and a fixing plate 42 is attached to the cover plate 3. The covering film 41 is formed of a flexible material having low rigidity such as a polyphenylene sulfide (PPS) film of 6 μm in thickness, and serves to close one of the sides of the manifold. The fixing plate 42 is formed of a hard material such as a metal, for example a stainless steel plate of 30 μm in thickness. The fixing plate 42 has an opening 43 formed in the thickness direction in dimensions corresponding to the entirety of the manifold 100, and therefore the mentioned side of the manifold 100 is closed solely with the covering film 41.

The compliance substrate 40 also includes an ink inlet 44 provided at a position opposing the manifold 100 for introducing therethrough the ink from an external liquid reservoir such as an ink cartridge or ink tank, into the manifold 100.

In this embodiment, further, the electrodes 60, 80 of the piezoelectric elements 300 of the first actuator member 2A and those of the second actuator member 2B, respectively, are drawn out to the surface of the cover plate 3 and connected to an external wiring.

More specifically, the electrodes 60, 80 of the piezoelectric elements 300 of the first actuator member 2A are each drawn out to the surface of the cover plate 3 opposite the second flow path plate 10B, through a corresponding lead-out wiring 92 provided in a contact hole 91 formed so as to penetrate through the second actuator member 2B and the cover plate 3 in the thickness direction Z.

Likewise, the electrodes 60, 80 of the piezoelectric elements 300 of the second actuator member 2B are drawn out to the surface of the cover plate 3 opposite the second flow path plate 10B, through a corresponding lead-out wiring 94 provided in a contact hole 93 formed so as to penetrate through the cover plate 3 in the thickness direction Z.

Each contact hole 91 through which the electrodes 60, 80 of the piezoelectric elements 300 of the first actuator member 2A are drawn out to the surface of the cover plate 3 is located between the adjacent second supply paths 14B of the second actuator member 2B in the first direction X. In this embodiment, Since the second supply path 14B is formed by narrowing the width (in the first direction X) of second pressure chamber 12B from the both sides, the pitch between the adjacent second supply paths 14B in the first direction X is wider than the pitch between the adjacent second pressure chamber 12B. Such a configuration allows the contact hole 91 to be formed with a large aperture without interfering with the second supply path 14B, thereby allowing the lead-out wiring 92 to be formed in a larger diameter, which leads to minimized risk of malfunctions originating from disconnection of the lead-out wiring 92, an increase in resistance of the lead-out wiring 92, and so forth.

The lead-out wirings 92 and 94 thus drawn out to the surface of the cover plate 3 are connected to an external wiring 110 such as a flexible printed circuit board (FPC) or a tape carrier package (TCP).

With the ink jet recording head 1 configured as above, the ink is supplied from an external ink reservoir (not shown) so as to fill the portion of the ink jet recording head 1 from the manifold 100 to the nozzle openings 21 (first nozzle openings 21A and second nozzle openings 21B) with the ink, and a voltage is applied between the first electrode 60 and the second electrode 80 of the respective pressure chambers 12 through the external wiring 110 in accordance with a recording signal from a driver circuit (not shown) to thereby cause flexural deformation of the piezoelectric element 300 and the vibrating plate 50. As a result, the pressure in the first pressure chamber 12A and the second pressure chamber 12B is changed, so that the ink droplet is dispensed through the nozzle openings 21 (first nozzle openings 21A and second nozzle openings 21B).

As described thus far, in this embodiment the first pressure chambers 12A and the second pressure chambers 12B are formed as a recess having an opening at the second face (5A, 5B) of each actuator member 2, such that the first pressure chambers 12A and the second pressure chamber 12B at least partially overlap when viewed in the direction in which the first actuator member 2A and the second actuator member 2B are stacked, i.e., in the thickness direction Z. Such a configuration allows the nozzle openings 21 to be arranged in higher density in the first direction X, and thus enables reduction in size of the actuator members 2 both in the first direction X and in the second direction Y.

In addition, the distance l₂ and the volume between the second pressure chamber 12B of the second actuator member 2B and the second nozzle opening 21B are set to be equal to the distance l₁ and the volume between the first pressure chamber 12A of the first actuator member 2A and the first nozzle opening 21A, and likewise the distance l₄ and the volume between the manifold 100 (second manifold region 13B) of the second actuator member 2B and the second pressure chamber 12B are set to be equal to the distance l₃ and the volume between the manifold 100 (first manifold region 13A) of the first actuator member 2A and the first pressure chamber 12A. Such a configuration provides uniform dispensing characteristics of the ink droplets ejected through the first nozzle openings 21A and the second nozzle openings 21B, thereby upgrading the printing quality.

### Embodiment 2

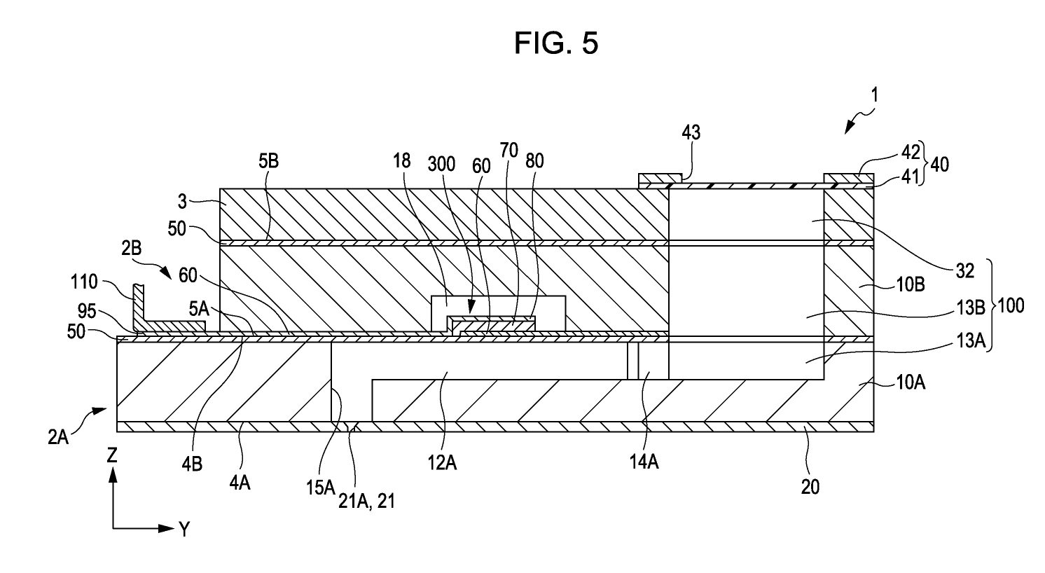

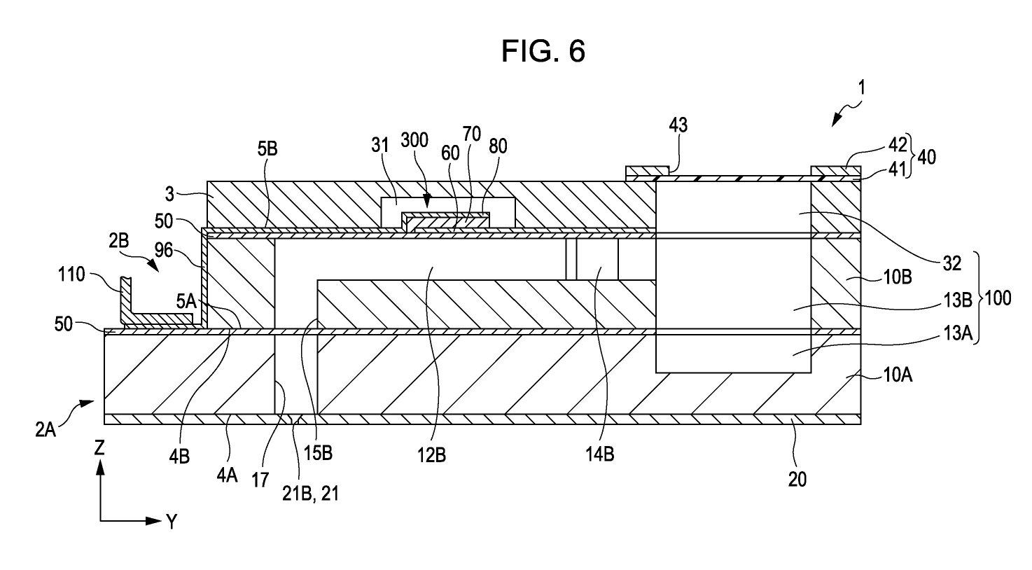

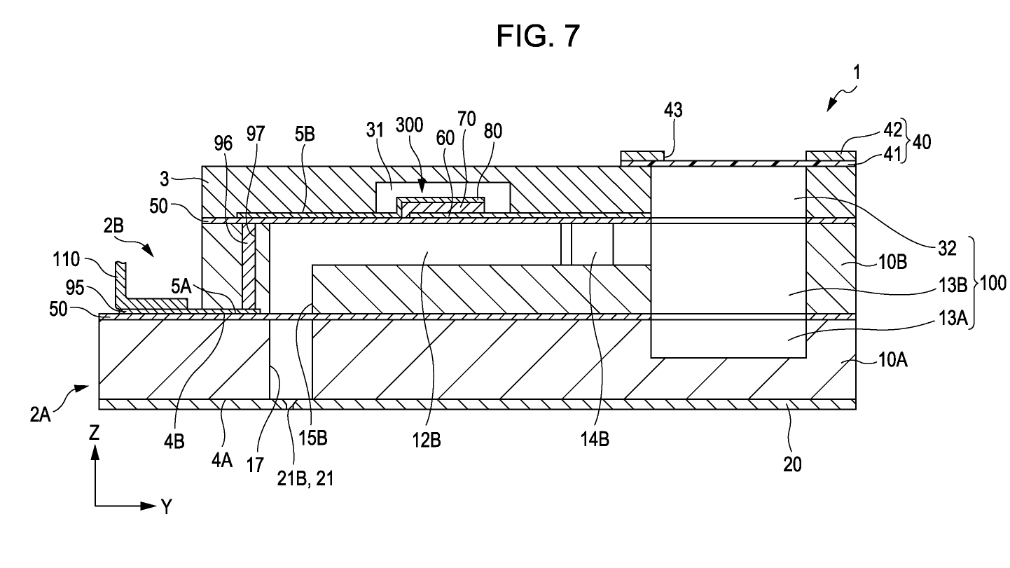

FIG. 5 is a cross-sectional view taken along the line V-V in FIG. 1, showing an ink jet recording head according to an embodiment 2 of the invention, exemplifying the liquid ejecting head. FIG. 6 is a cross-sectional view taken along the line VI-VI in FIG. 1, showing the ink jet recording head according to the embodiment 2. FIG. 7 is a drawing corresponding to the cross-sectional view taken along the line VII-VI in FIG. 1, showing a variation of the ink jet recording head according to the embodiment 2. The same constituents as those of the embodiment 1 will be given the same numeral, and the description thereof will not be repeated.

As shown in FIGS. 5 and 6, the ink jet recording head 1 according to this embodiment includes the first actuator member 2A, the second actuator member 2B, the nozzle plate 20, and the cover plate 3.

The first actuator member 2A is larger than the second actuator member 2B in the second direction Y, and an end portion of the first actuator member 2A on the side of the first nozzle communication path 15A in the second direction Y protrudes outwardly from the second actuator member 2B.

As shown in FIG. 5, the electrodes 60, 80 of the respective piezoelectric elements 300 of the first actuator member 2A extend to a region protruding from the second actuator member 2B by means of a lead-out wiring 95, and are electrically connected to the external wiring 110.

Likewise, as shown in FIG. 6, the electrodes 60, 80 of the respective piezoelectric elements 300 of the second actuator member 2B extend to a region on the first actuator member 2A protruding from the second actuator member 2B by means of a lead-out wiring 96, and are electrically connected to the external wiring 110.

The lead-out wiring 96 connected to the electrodes 60, 80 of the piezoelectric elements 300 of the second actuator member 2B may be provided, as shown in FIG. 7, in a contact hole 97 formed so as to penetrate through the second actuator member 2B in the thickness direction Z, instead of along the outer surface of the second actuator member 2B.

Providing thus the lead-out wiring 95 on the protruding region of the first flow path plate 10A of the first actuator member 2A for connection to the external wiring 110 allows an additional actuator member to be stacked on the second actuator member 2B on the surface opposite the first actuator member 2A.

### Embodiment 3

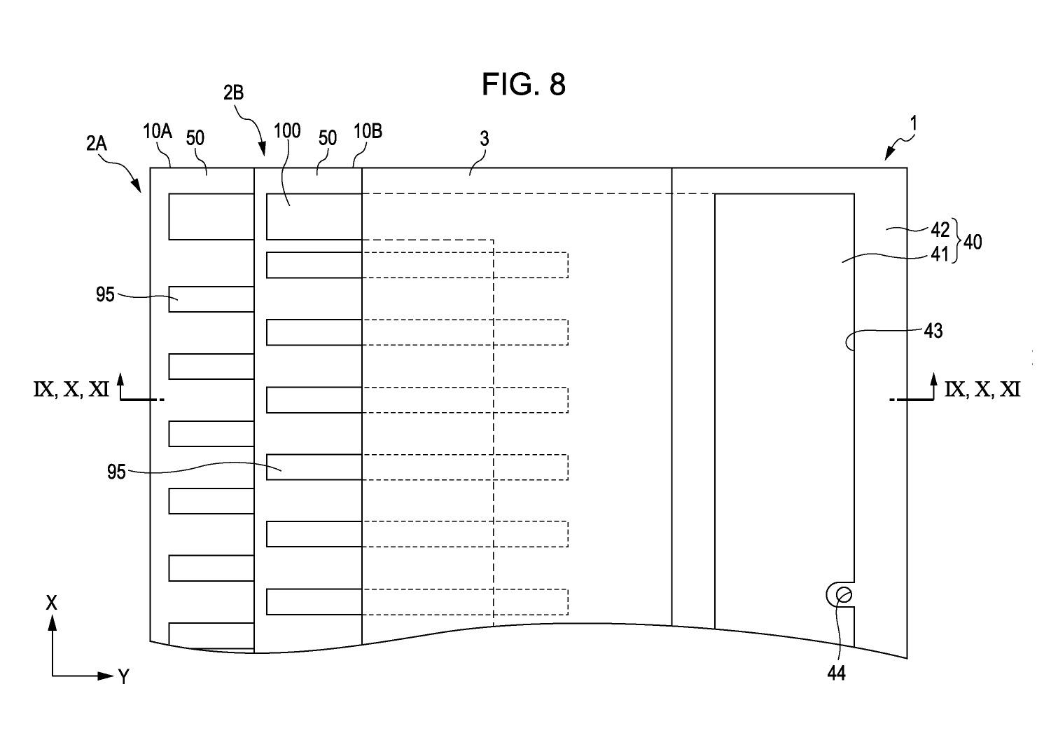

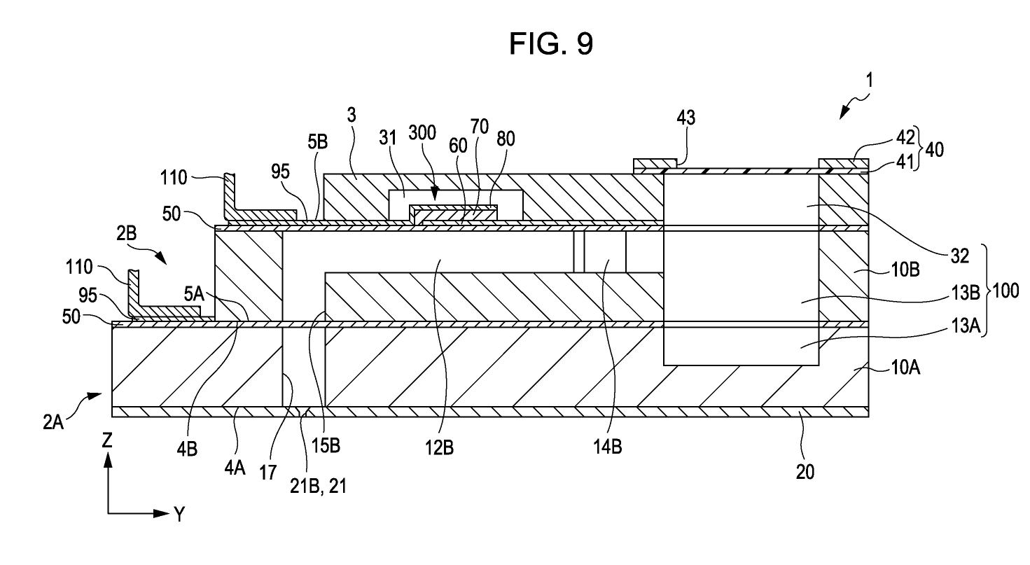

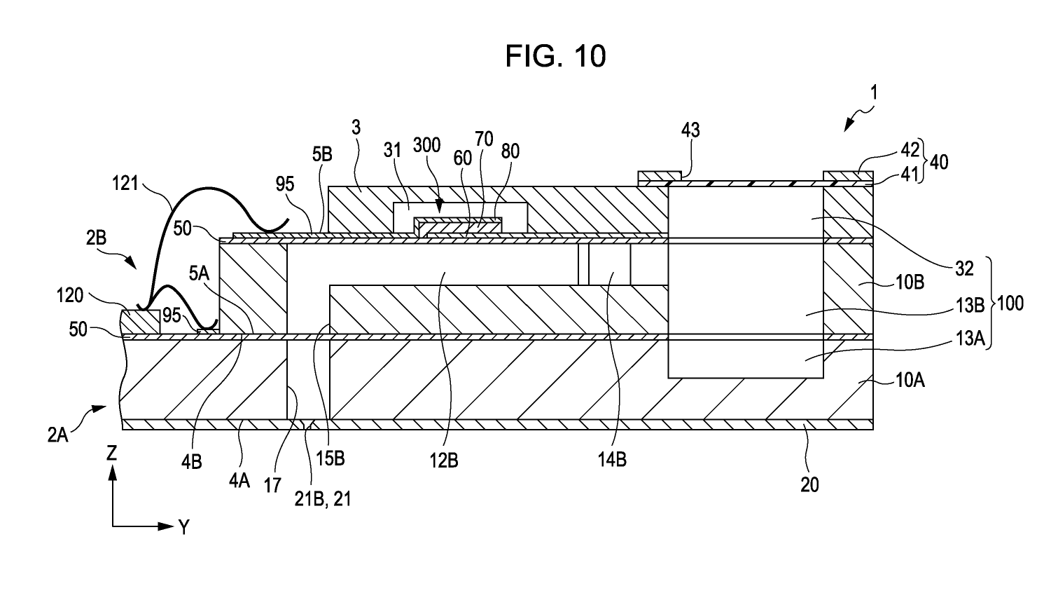

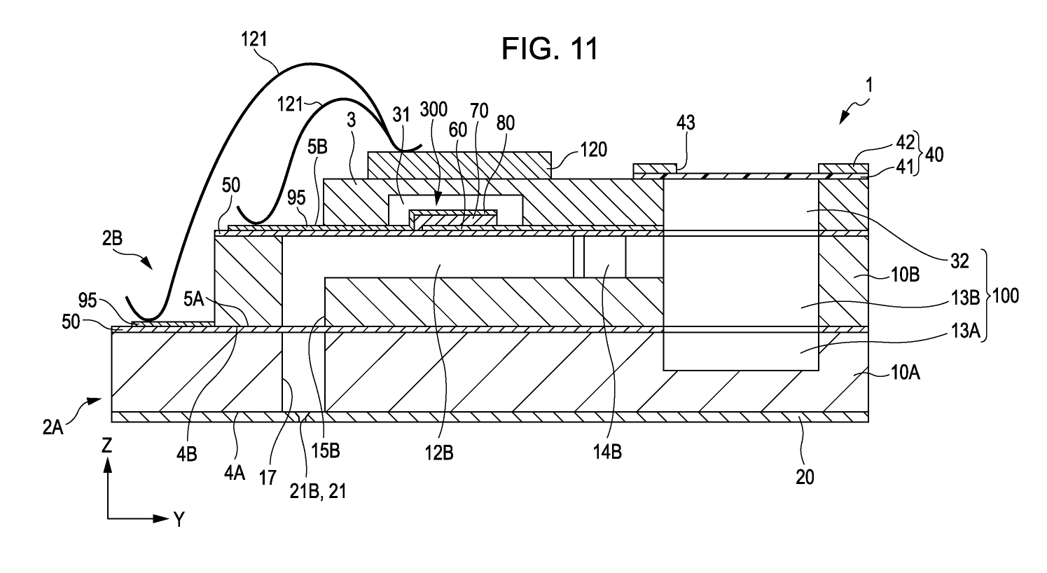

FIG. 8 is a plan view of an ink jet recording head according to an embodiment 3 of the invention, exemplifying the liquid ejecting head, and FIG. 9 is a cross-sectional view taken along a line IX-IX in FIG. 8. FIG. 10 is a drawing corresponding to the cross-sectional view taken along the line X-X in FIG. 8, showing a variation of the ink jet recording head according to the embodiment 3. Further, FIG. 11 is a drawing corresponding to the cross-sectional view taken along the line XI-XI in FIG. 8, showing another variation of the ink jet recording head according to the embodiment 3. The same constituents as those of the embodiment 1 will be given the same numeral, and the description thereof will not be repeated.

As shown in FIGS. 8 and 9, the ink jet recording head 1 according to this embodiment includes the first actuator member 2A, the second actuator member 2B, the nozzle plate 20, and the cover plate 3.

The first actuator member 2A (first flow path plate 10A) is, as in the embodiment 2 shown in FIGS. 5 and 6, larger than the second actuator member 2B (second flow path plate 10B) in the second direction Y, and an end portion of the first actuator member 2A on the side of the first nozzle communication path 15A in the second direction Y protrudes outwardly from the second actuator member 2B. In this embodiment, the vibrating plate 50 is provided over the region of the first flow path plate 10A protruding from the second flow path plate 10B.

The lead-out wiring 95 drawn out from the first electrode 60 and the second electrode 80 of the piezoelectric element 300 of the first actuator member 2A extends to a region on the vibrating plate 50 provided over the region of the first flow path plate 10A protruding from the second flow path plate 10B, and the leading end portion of the lead-out wiring 95 is electrically connected to the external wiring 110. In this embodiment, accordingly, the lead-out wiring 95 is located in the same plane as the vibrating plate 50 on which the piezoelectric elements 300 are provided, and an end portion of the lead-out wiring 95 is connected to the first electrode 60 or second electrode 80 of the piezoelectric element 300 and the other end portion extends to the region on the first flow path plate 10A (vibrating plate 50) protruding from the second actuator member 2B to be electrically connected to the external wiring 110.

In other words, the lead-out wiring 95 drawn out from the piezoelectric element 300, exemplifying the first pressure generator in the first actuator member 2A, extends along the surface of the first flow path plate 10A (vibrating plate 50) on which the piezoelectric element 300, exemplifying the first pressure generator, is provided, to the region uncovered with the second actuator member 2B.

In addition, the second actuator member 2B is larger than the cover plate 3 in the second direction Y, and an end portion of the second flow path plate 10B on the side of the second nozzle communication path 15B protrudes outwardly from the cover plate 3. In this embodiment, the vibrating plate 50 is also provided on the region of the second flow path plate 10B protruding from the cover plate 3.

The lead-out wiring 95 drawn out from the first electrode 60 and the second electrode 80 of the piezoelectric element 300, exemplifying the second pressure generator in the second actuator member 2B, extends to a region on the vibrating plate 50 provided over the region of the second flow path plate 10B protruding from the cover plate 3, and the leading end portion of the lead-out wiring 95 is electrically connected to the external wiring 110.

In this embodiment, accordingly, the lead-out wiring 95 is located in the same plane as the vibrating plate 50 on which the piezoelectric elements 300 are provided, and an end portion of the lead-out wiring 95 is connected to the first electrode 60 or second electrode 80 of the piezoelectric element 300 and the other end portion extends to the region on the second flow path plate 10B (vibrating plate 50) protruding from the cover plate 3 to be electrically connected to the external wiring 110.

In other words, the lead-out wiring 95 drawn out from the piezoelectric element 300, exemplifying the second pressure generator in the second actuator member 2B, is provided on the surface of the second flow path plate 10B (vibrating plate 50) on which the piezoelectric element 300 is provided.

Thus, the lead-out wirings 95 from the piezoelectric elements 300 of the respective actuator members 2 are drawn out to the surface on which the piezoelectric elements 300 of the flow path plates 10 of each actuator member 2 are provided, for connection to the external wiring 110. Such a configuration eliminates the need to route the lead-out wiring 95 in the thickness direction Z, thereby suppressing defective formation or disconnection of the lead-out wiring 95 and facilitating the actuator members 2 to be stacked in a multiple layers in the thickness direction Z.

Further, the lead-out wiring 95 of the ink jet recording head 1 shown in FIGS. 8 and 9 may be connected to a driver circuit such as a semiconductor IC, instead of the external wiring 110. Such an example is shown in FIGS. 10 and 11.

As shown in FIG. 10, a driver circuit 120 such as a semiconductor IC is fixed to the same plane as the surface on which the lead-out wirings 95 of the first flow path plate 10A of the first actuator member 2A are provided, i.e., the vibrating plate 50. The driver circuit 120 is electrically connected to the lead-out wirings 95 drawn out from the piezoelectric elements 300 in the first actuator member 2A and the lead-out wirings 95 drawn out from the piezoelectric elements 300 in the second actuator member 2B, through connection wirings 121 such as a bonding wire.

FIG. 11 depicts another configuration in which the driver circuit 120 such as a semiconductor IC is provided on the surface of the cover plate 3 opposite the second actuator member 2B. The driver circuit 120 is electrically connected to the lead-out wirings 95 drawn out from the piezoelectric elements 300 in the first actuator member 2A and the lead-out wirings 95 drawn out from the piezoelectric elements 300 in the second actuator member 2B, through connection wirings 121 such as a bonding wire.

As described above, the lead-out wirings 95 drawn out from the piezoelectric elements 300 may be connected to outside through the external wiring 110 as shown in FIGS. 7 to 9, or connected to the driver circuit 120 provided on the ink jet recording head 1 as shown in FIGS. 10 and 11.

### Embodiment 4

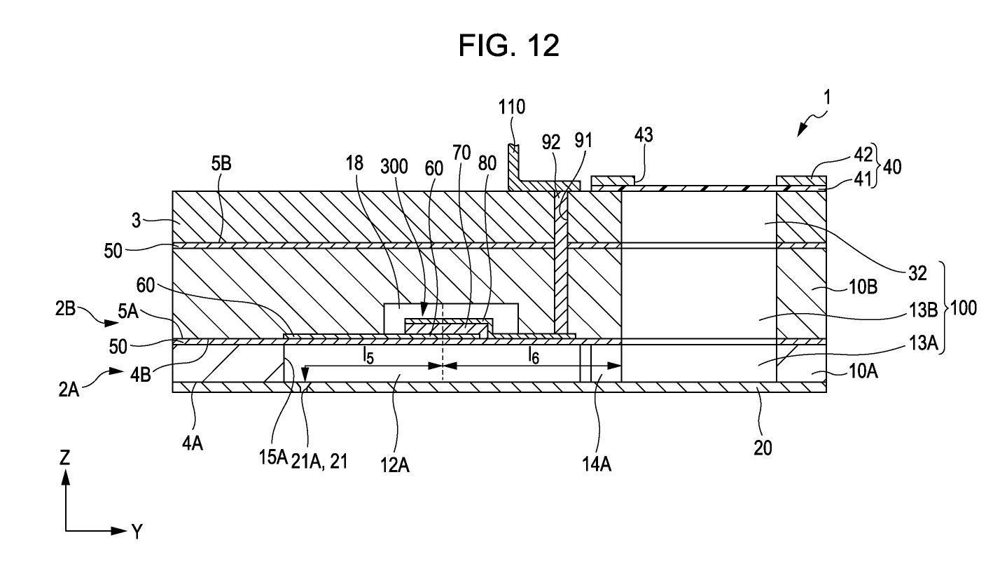

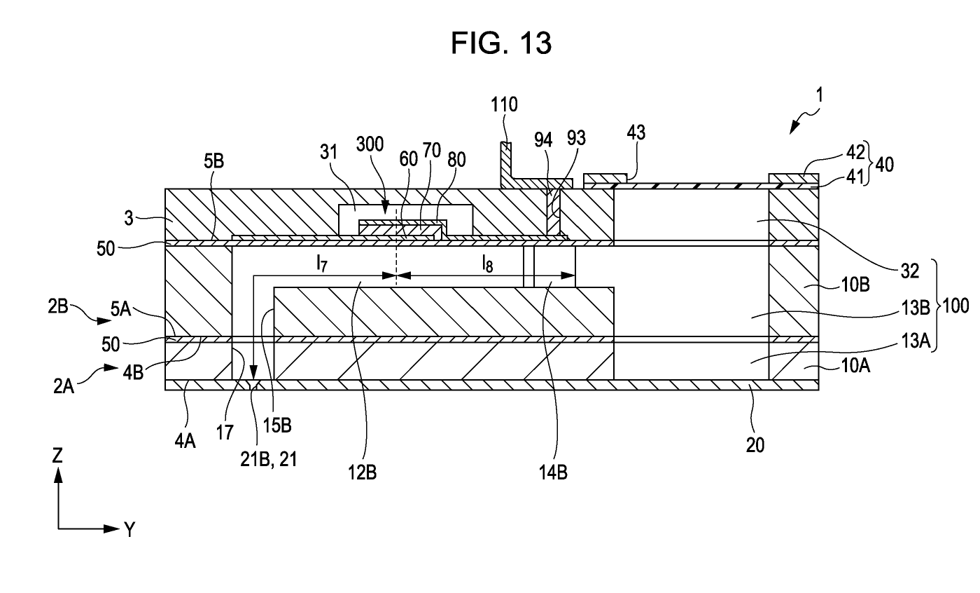

FIG. 12 is a drawing corresponding to the cross-sectional view taken along the line XII-XII in FIG. 1, showing an ink jet recording head according to an embodiment 4 of the invention, exemplifying the liquid ejecting head. FIG. 13 is a drawing corresponding to the cross-sectional view taken along the line XIII-XIII in FIG. 1, showing the ink jet recording head according to the embodiment 4. The same constituents as those of the foregoing embodiments will be given the same numeral, and the description thereof will not be repeated.

As shown in FIGS. 12 and 13, the ink jet recording head 1 according to this embodiment includes the first actuator member 2A, the second actuator member 2B, the nozzle plate 20, and the cover plate 3.

The first actuator member 2A includes the first flow path plate 10A, which includes the first pressure chambers 12A, the first manifold region 13A, and the first supply paths 14A formed so as to penetrate through the first flow path plate 10A in the thickness direction Z.

The openings of the first pressure chambers 12A, the first manifold region 13A, and the first supply paths 14A on the side of the first flow path plate 10A opposite the piezoelectric element 300 are covered with the nozzle plate 20.

Such a configuration allows the first pressure chambers 12A to directly communicate with the first nozzle opening 21A without the intermediation of the first nozzle communication path 15A, unlike in the embodiment 1.

The first actuator members 2A each include the vibrating plate 50 and the piezoelectric element 300 as in the embodiment 1.

The second actuator member 2B is attached to the second face 5A of the first actuator member 2A, on which the piezoelectric elements 300 are provided.

The second actuator member 2B includes, as in the embodiment 1, the second pressure chambers 12B and the second supply paths 14B, each formed as a recess open toward the second face 5B opposite the first face 4B, and formed so as not to reach the first face 4B, i.e., not to penetrate through the second flow path plate 10B in the thickness direction Z.

The second flow path plate 10B also includes the second manifold region 13B penetrating therethrough in the thickness direction Z and communicating with the first manifold region 13A.

In addition, the second flow path plate 10B includes the second nozzle communication paths 15B, and the second pressure chambers 12B each communicate with the second nozzle opening 21B through the second nozzle communication path 15B and the connection path 17.

The first actuator member 2A and the second actuator member 2B are configured, as in the embodiment 1, such that a distance l₅ and a volume between the center of vibration in the second direction Y of the vibrating plate 50 on the individual flow paths of the first actuator member 2A and the first nozzle opening 21A are equal to a distance l₇ and a volume between the center of vibration in the second direction Y of the vibrating plate 50 on the individual flow paths of the second actuator member 2B and the second nozzle opening 21B. Likewise, a distance l₆ and a volume between the center of vibration in the second direction Y of the vibrating plate 50 on the individual flow paths of the first actuator member 2A and the manifold 100 (first manifold region 13A) are equal to a distance l₈ and a volume between the center of vibration in the second direction Y of the vibrating plate 50 on the individual flow paths of the second actuator member 2B and the manifold 100 (second manifold region 13B).

Such a configuration provides the same dispensing characteristics (flying speed and weight of ink droplets) to the ink droplets ejected through the first nozzle openings 21A and to those ejected through the second nozzle opening 21B, thus allowing the ink droplets to land on the recording medium with uniform dispensing characteristics.

Although the individual flow paths of the first actuator member 2A, each including the first pressure chamber 12A and the first supply path 14A, are formed so as to penetrate through the first flow path plate 10A in the thickness direction Z, the first individual flow paths of the actuator member 2A and those of the second actuator member 2B can be located so as to overlap in a view in the thickness direction Z, provided that at least the second pressure chambers 12B and the second supply paths 14B are formed as a recess open toward the second face 5B opposite the first actuator member 2A. In this case, however, the first flow path plate 10A and the second flow path plate 10B have to be formed of materials of different thicknesses.

### Embodiment 5

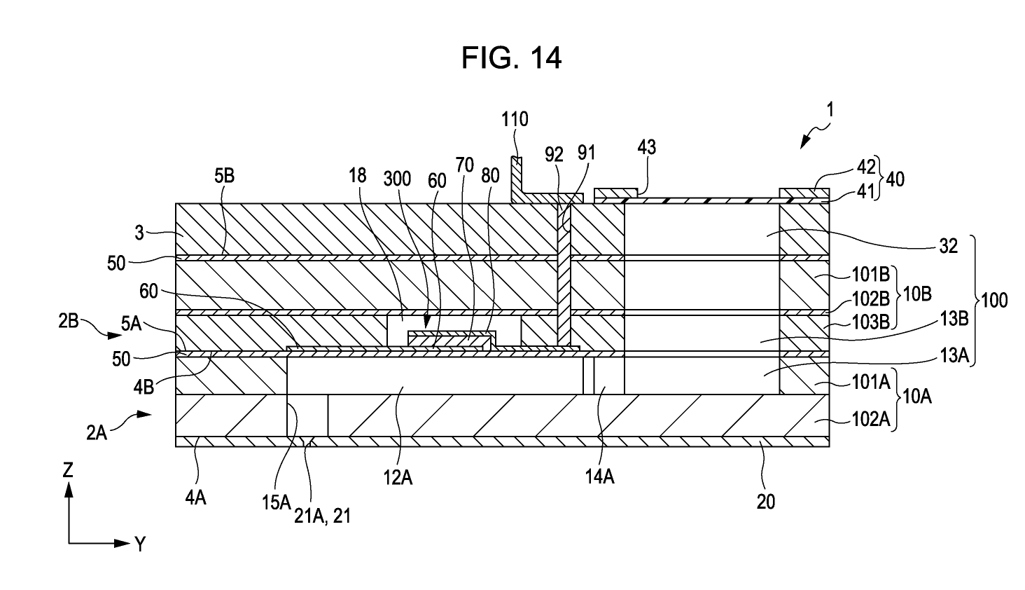

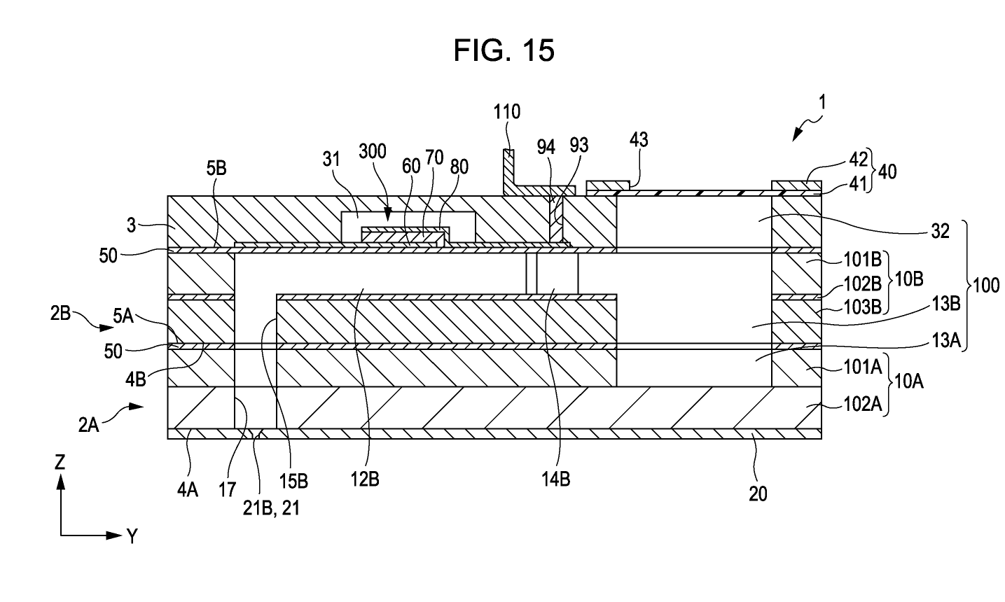

FIG. 14 is a drawing corresponding to the cross-sectional view taken along the line XIV-XIV in FIG. 1, showing an ink jet recording head according to an embodiment 5 of the invention, exemplifying the liquid ejecting head. FIG. 15 is a drawing corresponding to the cross-sectional view taken along the line XV-XV in FIG. 1, showing the ink jet recording head according to the embodiment 5. The same constituents as those of the foregoing embodiments will be given the same numeral, and the description thereof will not be repeated.

As shown in FIGS. 14 and 15, the ink jet recording head 1 according to this embodiment includes the first actuator member 2A, the second actuator member 2B, the nozzle plate 20, and the cover plate 3.

The first actuator member 2A includes the first flow path plate 10A, which includes a first substrate for first flow path plate 101A and a second substrate for first flow path plate 102A stacked on each other.

The first substrate for first flow path plate 101A includes the first pressure chambers 12A, the first manifold region 13A, the first supply paths 14A and a part of the first nozzle communication paths 15A, formed so as to penetrate therethrough in the thickness direction Z.

The second substrate for first flow path plate 102A includes another part of the first nozzle communication paths 15A formed so as to penetrate therethrough in the thickness direction Z. The first flow path plate 10A also includes the connection paths 17 penetrate therethrough in the thickness direction Z.

The second actuator member 2B includes the second flow path plate 10B, which includes a first substrate for second flow path plate 101B, a second substrate for second flow path plate 102B, and a third substrate for second flow path plate 103B, sequentially stacked on each other.

The first substrate for second flow path plate 101B includes, like the first substrate for first flow path plate 101A, the second pressure chambers 12B, a part of the second manifold region 13B, the second supply paths 14B and a part of the second nozzle communication paths 15B, formed so as to penetrate therethrough in the thickness direction Z.

The second substrate for second flow path plate 102B includes another part of the second nozzle communication paths 15B and another part of the second manifold region 13B, formed so as to penetrate therethrough in the thickness direction Z.

The third substrate for second flow path plate 103B includes still another part of the second nozzle communication paths 15B, still another part of the second manifold region 13B, and the first retention chamber 18, formed so as to penetrate therethrough in the thickness direction Z. Here, the first retention chamber 18 is not provided in the first substrate for second flow path plate 101B and the second substrate for second flow path plate 102B, and the opening of the first retention chamber 18 on one side is covered with the second substrate for second flow path plate 102B.

Forming thus the first flow path plate 10A and the second flow path plate 10B with the substrates 101A, 102A, 101B, 102B, and 103B stacked on each other allows the flow paths and the retention chambers to be formed so as to penetrate through the respective substrates, without the need to form the recessed flow paths and retention chambers 18 through a half etching process or the like. Such a configuration provides a broader selection range of the materials and processing methods.

### Additional Embodiments

Although some embodiments of the invention have been described above, the basic structure of the invention is not limited thereto. For example, although in the embodiment 1 the individual flow paths of the first actuator member 2A and the second actuator member 2B are composed of the first pressure chamber 12A and the first supply path 14A, and the second pressure chamber 12B and the second supply path 14B, respectively, a communication path may be provided between each of the first supply paths 14A and the first manifold region 13A, or between each of the second supply paths 14B and the second manifold region 13B.

Although the first pressure chambers 12A of the first actuator member 2A are aligned in the first direction X in the embodiment 1, alternatively the first pressure chambers 12A of the first actuator member 2A may be composed of two or more rows aligned in the second direction Y, each row including the pressure chambers aligned in the first direction X. In other words, a plurality of rows may be provided in the first flow path plate 10A, each row including the first pressure chambers 12A aligned in the first direction X. This naturally applies also to the second actuator member 2B, and a plurality of rows may be provided in the second flow path plate 10B, each row including the second pressure chambers 12B aligned in the first direction X.

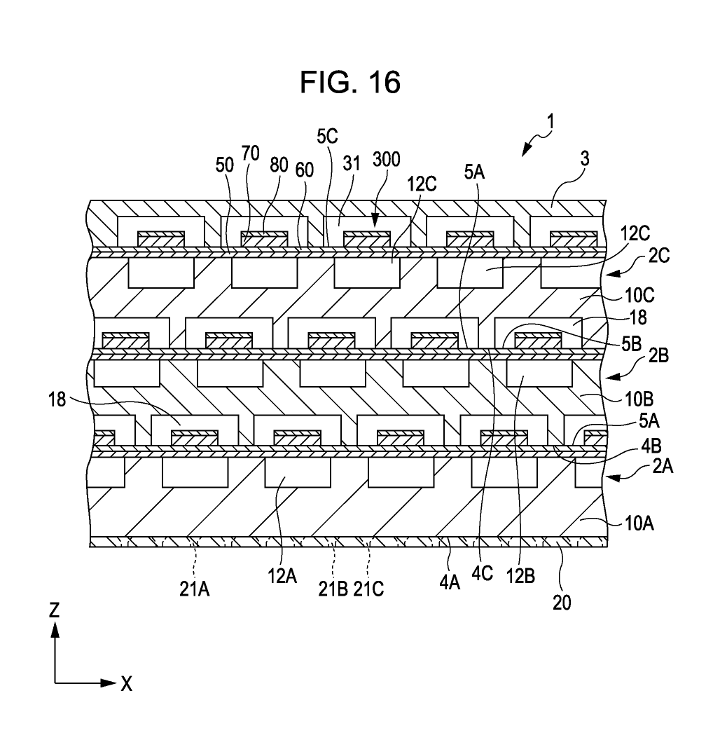

Further, although two actuator members (2A, 2B) are provided in the ink jet recording head 1 in the foregoing embodiments, three or more actuator members 2 may be provided. Here, an example including three actuator members is shown in FIG. 16. FIG. 16 is a drawing corresponding to the cross-sectional view taken along the line XVI-XVI in FIG. 1, showing an ink jet recording head according to an additional embodiment of the invention.

As shown in FIG. 16, the nozzle plate 20 includes the first nozzle row including the first nozzle openings 21A aligned in the first direction X, the second nozzle row including the second nozzle openings 21B aligned in the first direction X, and a third nozzle row including third nozzle openings 21C aligned in the first direction X, the first to the third nozzle rows being aligned in the second direction Y.

The second nozzle row and the third nozzle row are shifted in the first direction X from the first nozzle row by one third of the pitch between the adjacent first nozzle openings 21A of the first nozzle row in the first direction X. In other words, the second nozzle opening 21B and the third nozzle opening 21C are located at regular intervals in the first direction X between the adjacent first nozzle openings 21A in the first direction X.

In addition, a third actuator member 2C is provided on the second face 5B of the second actuator member 2B. A third flow path plate 10C constituting the third actuator member 2C includes individual flow paths composed of third pressure chambers 12C, like the second actuator member 2B. Although not shown, the third actuator member 2C also includes a third manifold region constituting a part of the manifold 100, third supply paths communicating between the third pressure chambers 12C and the manifold 100, and third nozzle communication paths communicating between the third pressure chambers 12C and the third nozzle openings 21C, like the second actuator member 2B. Further, the third flow path plate 10C includes the piezoelectric elements 300 with the vibrating plate 50 therebetween. The third flow path plate 10C also includes the first retention chambers 18 that each accommodate the piezoelectric element 300 of the second actuator member 2B, on the side of the first face 4C, and the cover plate 3 is provided on the second face 5C.

In this configuration, the second actuator member 2B and the third actuator member 2C correspond to the first actuator member and the second actuator member of the invention, respectively, and the individual flow paths of the second actuator member 2B and those of the third actuator member 2C may be arranged so as to at least partially overlap in a view in the thickness direction Z. Such a configuration allows the three nozzle rows to be arranged in high density in the ink jet recording head 1, thereby enabling high-density printing to be performed and the ink jet recording head 1 to be built in smaller dimensions both in the first direction X and in the second direction Y.

Although the embodiment 1 represents the ink jet recording head 1 including the thick-film type piezoelectric elements 300, the pressure generator that causes pressure fluctuation in the first pressure chamber 12A (first pressure generator) and in the second pressure chamber 12B (second pressure generator) may be, for example, a thin-film type piezoelectric element constituted of a piezoelectric material formed through a sol-gel process, an MOD process, or a sputtering process, or an electrostatic actuator including the vibrating plate 50 and electrodes disposed with a predetermined gap therebetween so as to control the vibration of the vibrating plate 50 with static electricity. Further, the pressure generator may be composed of two or more piezoelectric elements 300 according to the embodiment 1 stacked in the direction in which the first actuator member 2A and the second actuator member 2B are stacked.

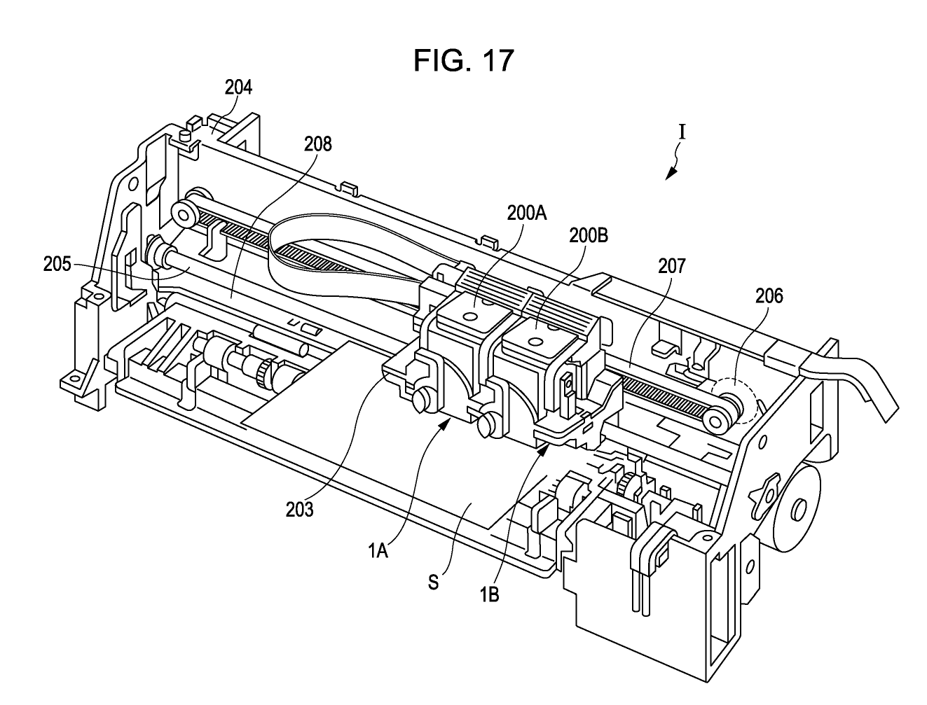

The foregoing ink jet recording head 1 may be employed in a recording head unit including ink flow paths communicating with an ink cartridge or the like, mounted in an ink jet recording apparatus. FIG. 17 is a schematic drawing showing an example of the ink jet recording apparatus.

As shown in FIG. 17, the ink jet recording apparatus I includes the recording head units 1A and 1B, each including the ink jet recording head 1. Cartridges 200A and 200B each constituting an ink supplier are removably mounted on the recording head units 1A, 1B, respectively, and a carriage 203 on which the recording head units 1A and 1B are mounted is disposed so as to axially reciprocate along a carriage shaft 205 installed in the apparatus main body 204. The recording head units 1A and 1B are set to dispense, for example, a black color composition and a color ink composition, respectively.

When the driving force of a driving motor 206 is transmitted to the carriage 203 through a plurality of gears (not shown) and a timing belt 207, the carriage 203 on which the recording head units 1A and 1B are mounted is caused to reciprocate along the carriage shaft 205. A platen 208 is provided along the carriage shaft 205 in the apparatus main body 204, so that a recording sheet S, exemplifying the recording medium, fed by a paper feed roller (not shown) can be engaged on the platen 208 thus to be transported.

Although the ink jet recording apparatus I is configured such that the ink jet recording head 1 (head units 1A, 1B) is mounted on the carriage 203 so as to reciprocate in the main scanning direction, the invention may also be applied to, for example, a line recording apparatus in which the ink jet recording head 1 is fixed and the recording sheet S is moved in the sub-scanning direction.

Further, although the foregoing embodiments refer to the ink jet recording head as an example of the liquid ejecting head, the invention is broadly applicable to generally available liquid ejecting heads, including those that eject a liquid other than ink. Examples of such liquid ejecting apparatus include various recording heads employed in image recording apparatuses such as a printer, a color material ejecting head for manufacturing color filters for a liquid crystal display or the like, an electrode material ejecting head for manufacturing electrodes for an electroluminescence (EL) display or a field emission display (FED), chip manufacturing apparatuses for manufacturing biochips (biochemical elements), and a bioorganic ejecting head for manufacturing biochips.

The entire disclosure of Japanese Patent Application No. 2011-253279, filed Nov. 18, 2011 is incorporated by reference herein.

What is claimed is:

1. A liquid ejecting head comprising:
a nozzle plate having a first nozzle row including a plurality of nozzle openings aligned in a first direction and a second nozzle row including a plurality of nozzle openings aligned in the first direction, the first nozzle row and the second nozzle row being aligned in a second direction orthogonal to the first direction, such that the nozzle openings of the first nozzle row and the nozzle openings of the second nozzle row are deviated from each other in the first direction;
a first actuator member communicating via a first face thereof with the nozzle openings of the first nozzle row, and including a first flow path plate including a plurality of individual flow paths each having an opening on the side of a second face opposite the first face, a vibrating plate provided on the side of the second face of the first flow path plate opposite the first face, and a plurality of first pressure generators that change pressure in the individual flow paths; and
a second actuator member provided on the second face of the first actuator member and communicating via a first face thereof with the nozzle openings of the second nozzle row, and including a second flow path plate including a plurality of individual flow paths each formed as a recess having an opening on the side of a second face of the second actuator member opposite the first face and a plurality of nozzle communication paths each communicating between the individual flow path and the nozzle opening located on the side of the first face, a vibrating plate provided on the side of the second face of the second flow path plate, and a plurality of second pressure generators that change pressure in the individual flow paths,
wherein the individual flow paths of the first actuator member and the individual flow paths of the second actuator member are arranged so as to at least partially overlap when viewed in the direction in which the first actuator member and the second actuator member are stacked.

2. The liquid ejecting head according to claim 1,
wherein the second actuator member includes first retention chambers each formed as a recess having an opening on the side of the first actuator member so as to accommodate the first pressure generator provided on the vibrating plate in the first actuator member, and the first retention chambers are located so as to at least partially overlap the individual flow path in the second actuator member, in a view in the direction in which the first actuator member and the second actuator member are stacked.

3. The liquid ejecting head according to claim 1, further comprising a cover plate placed on the second face of the second actuator member, the cover plate including second retention chambers that each accommodate the second pressure generator provided on the vibrating plate in the second actuator member.

4. The liquid ejecting head according to claim 3,
wherein a lead-out wiring drawn out from the first pressure generator of the first actuator member and the second pressure generator of the second actuator member is disposed so as to extend to a surface of the cover plate opposite the second actuator member, and connected to an external wiring.

5. The liquid ejecting head according to claim 1,
wherein a lead-out wiring drawn out from the first pressure generator of the first actuator member and the second pressure generator of the second actuator member is disposed so as to extend to a region on the second face the first actuator member uncovered with the second actuator member, and electrically connected to an external wiring.

6. The liquid ejecting head according to claim 1,
wherein a lead-out wiring drawn out from the first pressure generator of the first actuator member is disposed so as to extend to a region uncovered with the second actuator member, on the side of the first flow path plate on which the first pressure generator is provided, and
a lead-out wiring drawn out from the second pressure generator of the second actuator member is disposed on the side of the second flow path plate on which the second pressure generator is provided.

7. The liquid ejecting head according to claim 1,
wherein the first and the second actuator member include a manifold communicating in common with the plurality of pressure chambers, and
the individual flow paths of the first actuator member and the individual flow paths of the second actuator member have the same distance and volume between the manifold and the center of vibration of the vibrating plate on the individual flow path, and the same distance and volume between the center of vibration of the vibrating plate on the individual flow path and the nozzle opening.

8. A liquid ejecting apparatus comprising the liquid ejecting head according to claim 1.

9. A liquid ejecting apparatus comprising the liquid ejecting head according to claim 2.

10. A liquid ejecting apparatus comprising the liquid ejecting head according to claim 3.

11. A liquid ejecting apparatus comprising the liquid ejecting head according to claim 4.

12. A liquid ejecting apparatus comprising the liquid ejecting head according to claim 5.

13. A liquid ejecting apparatus comprising the liquid ejecting head according to claim 6.

14. A liquid ejecting apparatus comprising the liquid ejecting head according to claim 7.
